(19) United States
(12) Patent Application Publication
(10) Pub. No.: US 2011/0093510 A1
(43) Pub. Date: Apr. 21, 2011

(54) METHODS AND SYSTEMS FOR SERIALLY TRANSMITTING RECORDS IN XML FORMAT

(75) Inventors: Timothy Beck, Pendleton, IN (US); Igor Gejdos, Indianapolis, IN (US)

(73) Assignee: ROCHE DIAGNOSTICS OPERATIONS, INC., Indianapolis, IN (US)

(21) Appl. No.: 12/581,979

(22) Filed: Oct. 20, 2009

(51) Int. Cl. G06F 17/00; G06F 13/00; H04L 9/00

(52) U.S. Cl. 707/803; 707/812; 710/31; 710/31; 707/E17.127; 707/E17.01

(57) ABSTRACT

A portable electronic medical device and method for serially transmitting one or more records from the portable electronic medical device are disclosed. The portable electronic medical device includes a processor and memory for storing the one or more records, each record having one or more data entries. An XML (Extensible Markup Language) template may be parsed by the processor, wherein the XML template has one or more XML elements associated with the one or more data entries. The one or more records may be read as well as the XML elements appended to the associated data entries of each record by the processor such that the appended data entries are in XML format. The processor may then serially transmit the appended data entries of each record.

### TECHNICAL FIELD

Embodiments of the present invention relate generally to data communications, and in particular to methods and systems for serially transmitting records from a portable electronic medical device in XML format.

### BACKGROUND

Portable electronic medical (PEM) devices, such as blood glucose (bG) meters, insulin pumps, and continuous glucose monitoring devices, are used for managing diabetes and other chronic diseases. The ability of these devices to exchange information between each other devices as well as between a device and a personal computer (PC) has become a standard feature.

Conventional methods include exchanging data in binary format as well as encoding the data in a computer language, such as XML (Extensible Markup Language), and compressing the encoded data before transmitting. However, these methods, although suitable for certain types of medical devices, may pose significant disadvantages in other devices. For example, wired and wireless communications using a binary data communication schemes often require the recipient to decode a proprietary format. Furthermore, maintaining backward and forward compatibility of the communicated data format can be challenging when new data content is introduced and/or new devices are added into a multi-device system. Also, wired and wireless communication schemes in which a header is sent followed by delimited data may require the recipient to further transform the data into an XML format. Compression schemes typically require computational and other resources to compress and decompress the data, and they may also not be able to provide random access to the data, as is common for in-memory data storage.

Data which is formatted in XML is verbose and, as such, requires more memory resources compared to binary stored data. Using the standard XML-based data format can help to maintain backward and forward compatibility for data communication even when new types of data are introduced into the data format; however, the XML data may require more memory resources as compared to binary data storage. Converting between binary data and data in XML format requires more computational resources as well. Minimizing memory and computation resources may lower the manufacturing cost of devices and may decrease power consumption as well. Consequently, a need exists for providing an XML-compliant communication scheme for PEM devices which minimizes memory and computational resources.

### SUMMARY

It is against the above background that embodiments of the present invention may provide an intelligent XML parser for records stored in a PEM device. The XML parser may provide an XML-compliant interface while conserving device memory and other resources, thereby allowing the use of the XML data format for resource-constrained devices such as, for example, blood glucose meters and insulin pumps. The XML-compliant interface may enhance utilization of device data and may reduce lifecycle maintenance costs. Embodiments described herein may take into account a system of multiple collaborating devices and the clinical categorization of the records.

In one embodiment, a method is disclosed for serially transmitting one or more records from a portable electronic medical device to an external device, wherein the portable electronic medical device comprises a memory and a processor, the memory is in electrical communication with the processor, the memory comprises the one or more records, each record comprises one or more data entries, and the method comprises: having the processor parse an XML (Extensible Markup Language) template, the XML template including one or more XML elements associated with one or more data entries; having the processor read the one or more records; having the processor append the XML elements to the associated data entries of each record such that the appended data entries are in XML format; and having the processor serially transmit the appended data entries of each record to the external device.

In another embodiment, a method is disclosed for serially transmitting one or more records from a portable electronic medical device to an external device, wherein the portable electronic medical device comprises a memory and a processor, and the method comprises: having the processor read from the memory two or more XML (Extensible Markup Language) files, wherein each XML file comprises one or more records; having the processor combine the two or more XML files into a single, combined XML file, based on a pre-determined top level element; and having the processor serially transmitting the single, combined XML file to the external device.

In yet another embodiment, a method is disclosed for serially transmitting one or more records from a portable electronic medical device to an external device, wherein the portable electronic medical device comprises a memory and a processor, and the method comprises: having the processor read from the memory two or more XML (Extensible Markup Language) files, wherein each XML file comprises one or more records; having the processor read a combining template which provides instructions on combining the two or more XML files into a single, combined XML file; having the processor combine the two or more XML files into a single, combined XML file, based on the combining template; and having the processor serially transmitting the single, combined XML file to the external device.

In still another embodiment, a portable electronic medical device comprises: a communication device; a memory for storing one or more records, each record having one or more data entries; a processor in electrical communication with the communication device and memory; and a control program accessible by the processor to direct the processing of the one or more records and data entries by the processor, the control program when executed on the processor causes the processor to: read the one or more records from the memory, parse an XML (Extensible Markup Language) template comprising one or more XML elements associated with the one or more data entries, append the XML elements to the associated data entries of each record such that the appended data entries are in XML format, and serially transmit the appended data entries of each record via the communication device.

These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a block diagram depicting a portable electronic medical device according one or more embodiments shown and described herein;

FIG. 2A depicts records according one or more embodiments shown and described herein;

FIG. 2B depicts records stored in memory according to one or more embodiments shown and described herein;

FIG. 3 depicts records stored in memory according to one or more embodiments shown and described herein;

FIG. 4A depicts an XML template according one or more embodiments shown and described herein;

FIG. 4B depicts appended data entries according one or more embodiments shown and described herein;

FIG. 5 is a flow chart depicting acts used to transmit records in XML format from a portable electronic medical device according one or more embodiments shown and described herein; and

FIGS. 6 and 7 are flow charts depicting acts used to combine two or more XML files containing records according one or more embodiments shown and described herein.

### DETAILED DESCRIPTION

The embodiments of the present invention allow communication of data in XML format between resource-constrained devices, such as blood glucose (bG) meters, insulin pumps and continuous glucose monitors, and similar devices. Such resource-constrained devices will be collectively referred to herein as portable electronic medical (PEM) devices. The methods and systems described herein may reduce the memory and computational resource requirements of the PEM devices.

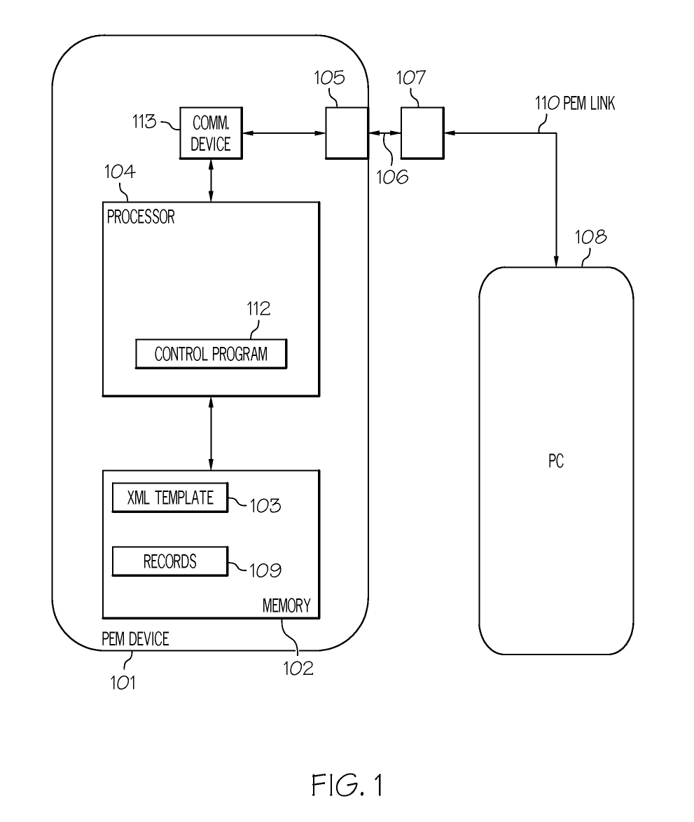

FIG. 1 depicts an exemplary system in which a PEM device 101 is operable to transmit records in XML format. As discussed herein, PEM devices include, but are not limited to, bG meters, insulin pumps, continuous glucose monitors, and similar devices. The PEM device 101 may comprise a memory 102, a processor 104, and a communication port 105. The PEM device 101 may further comprise other components (not shown), such as a display, a power supply, a keyboard, and so forth. The memory 102 may comprise an XML template 103 and records 109. The memory 102 may be a flash memory, an electrically-erasable programmable read only memory (EEPROM), battery-backed static random access memory (RAM), or other suitable memory. Furthermore, the memory 102 may have a parallel or serial interface to the processor 104.

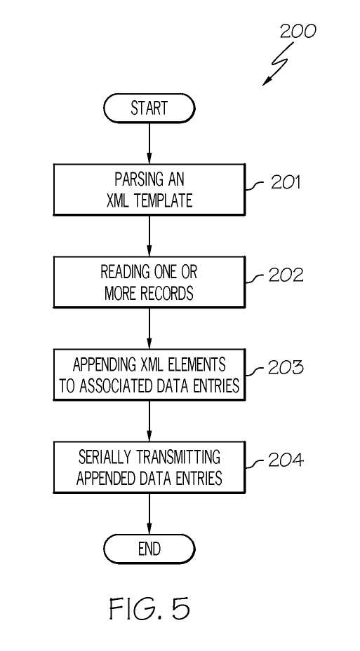

The processor 104 may comprise a microprocessor, microcontroller, ASIC processor, or other suitable processing device. The processor 104 may also comprise memory, timers, and other similar peripherals. For example, the processor 104 may comprise non-volatile flash memory for storing a control program 112 and RAM for temporary storage. Alternatively, the control program 112 may be stored in the memory 102. The control program 112 may be accessible by the processor 104, such as from flash memory or memory 102, to direct the processing of the XML template 103 and records 109 by the processor 104. When executed on the processor, the control program 112 may cause the processor 104 to perform the processes and features of the inventive embodiments, such as the processes illustrated by FIGS. 5, 6, and 7 which are discussed hereafter. In addition, it is contemplated that the processor 104 may also comprise the memory 102 as well as the control program 112. Alternatively, the processor 104 and the memory 102 may be separate components.

Continuing to refer to FIG. 1, the PEM device 101 may further comprise a communication device 113 which is in electrical communication with the processor 104. The communication device 113 may also be in electrical communication with the communication port 105 and may facilitate serial communication with external devices such as other PEM devices or a personal computer (PC) 108. As such, the communication device 113 may enable wired communications (TTL, RS-232, USB, FireWire, etc) via the communication port 105, wireless communication via infrared (e.g., IrDA) or radio frequency (RF) (e.g., Bluetooth, UWB, Z-Wave, ZigBee, etc.), or both such that the processor 104 may send and receive data as described herein. In one embodiment, memory 102, the processor 104, and communication device 113 may be separate components. In an alternative embodiment, they may be integrated into a single component, such as an Application Specific Integrated Circuit (ASIC) or a Programmable Gate Array (PGA). A dongle 107 may be coupled to the communication port 105 in order to convert the serial communication stream into a suitable format. For example, the communication port 105 may have a wired interface 106, such as TTL or RS-232, and the dongle 107 may convert this wired interface 106 into the PEM device link 110. The PEM device link 110 may permit communication between PEM devices or between a PEM device and a PC 108. Although denoted as a personal computer, the PC 108 may also comprise a portable communicator, such as a cellular phone, a smart phone, or a personal digital assistant.

In order to communicate XML data over the PEM device link 110 to the PC 108 (with or without dongle 107), the processor 104 of the PEM device 101 locates and reads the XML template 103, renders in memory 102 the records 109 into XML format, and communicates XML data via communication port 105 of the PEM device. In one embodiment, the XML template 103 may be stored in the memory 102 (as depicted in FIG. 1) or the control program 112. In another embodiment, the processor 104 may receive the XML template 103 from an external device, such as another PEM device or the PC 108. After rendering, the records (which have been converted to XML format) may be temporarily stored in the memory 102 or the processor 104. Alternatively, the records (in XML format) may be immediately communicated as they are being rendered, without being stored in memory.

The PEM device link 110 may be a wired link, such as Universal Serial Bus (USB) and Ethernet, or it may be a wireless link, such as Bluetooth, Zigbee, infrared, and so forth. A variety of dongles may be available, each of which may provide a specific type of link. A user of the PEM device may be able to install a USB dongle, a Bluetooth dongle, etc. Alternatively, the communication port 105 and the dongle 107 may be combined so that the PEM device 101 always supports one or more types of links. As an example, a PEM device 101 may comprise a communication port 105 which only provides Bluetooth capability. This type of PEM device may not be as flexible as one employing a dongle (which may support a variety of wired or wireless interfaces), but it may be less expensive and more compact.

The PC 108, to which the PEM device 101 communicates, may be a desktop or a laptop computer. Alternatively, the PC 108 may also be a smart phone, a personal digital assistant, or other type of personal communicator. For example, the PC 108 may be a smart phone, and the PEM device link 110 may be Bluetooth. In this example, the PEM device 101 and the smart phone may be operable to transmit data to each other. The smart phone may request that the PEM device 101 send the records stored in its memory to the smart phone. In response, the PEM device 101 may read the records stored in its memory and transmit the records in XML-format to the smart phone.

As discussed herein, the PEM device link 110 between PEM devices or between a PEM device and a PC may be wired or wireless. For example, blood glucose meters may wirelessly transmit glucose measurements via an infrared port. The infrared port may permit the PC to receive data from the blood glucose meter and transmit it to an information management host device such as a personal computer or mobile device (Smartphone, personal digital assistant, etc.)

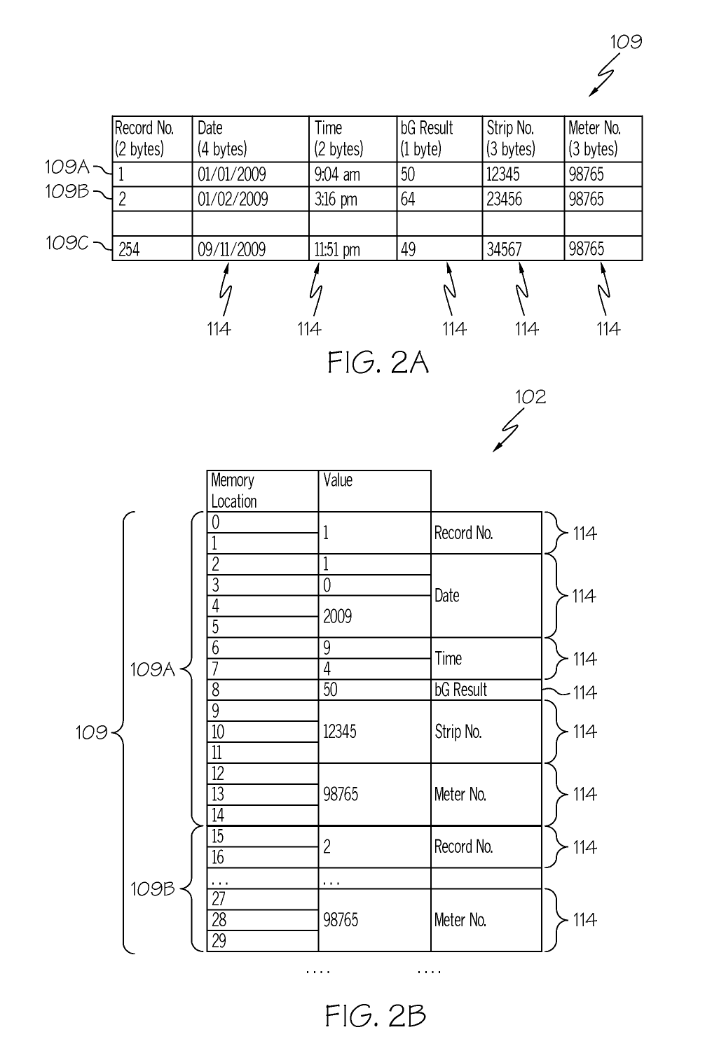

FIG. 2A depicts an example of records 109 which may be stored in a PEM device. This figure shows three records 109A, 109B, 109C, and in one embodiment a total of 254 records may be provided; however, in other embodiments any number of records is possible depending on device resources, such as memory capacity. Each record may have one or more data entries 114, such as “Record No.,” “Date,” “Time,” “bG Result,” “Strip No.,” and “Meter No.” The data entries 114 may correspond to each tabular entry as depicted in the table of FIG. 2A, whereas the records may correspond to the collective entries in each row. Other types of data entries 114 may be used as well, and the number of data entries may one, two, six (as depicted), or any other suitable value. The types of records 109 may be medical (e.g., the “bG Result”) or may be non-medical (e.g., the “Date”).

FIG. 2B illustrates an example of how records 109 may be stored in a memory 102 of the PEM device 101. In this example, the memory 102 may comprise a suitable number of locations to permit the PEM device store all of the records 109. Each memory location has an address and may store a single byte (i.e., eight bits, or binary digits), and each record 109 in the example in FIG. 2A requires 15 bytes of storage. Thus, one record 109A may be stored in memory locations addressed 0 through 14, another record 109B may be stored in memory locations addressed 15 through 29, and so forth. In one embodiment, a pointer(s) may be provided by the processor 104 in one memory location to point to other memory location(s) whose value refers to another value stored elsewhere in the memory 102 using its address. Such may be useful in embodiments where a record 109 is stored by the processor 104 in memory 102 in non-sequential memory locations. Data entries 114 which require two or more bytes may be stored in the memory with the least-significant byte first (“little endian”) or the most-significant byte first (“big endian”). The data entries 114 which do not end on a byte boundary may be “packed” with other data entries 114 by the processor 104. It is contemplated that memories having other widths (e.g., widths of one nibble (4 bits) or one word (16 bits)) may be used as well. FIGS. 2A and 2B depict the data entries 114 as having a fixed length. It is contemplated that other types of data entries may be used as well for each record, and the length of each data entry may be set to a suitable number of bytes. Furthermore, each data entry 114 may comprise a fixed number of bits that is not a multiple of one byte. As an example, the “Date” entry may alternatively comprise 18 bits: 4 bits for the month (1-12), 6 bits for the date (1-31), and 8 bits for the year (0-255, where 0=1970, 1=1971, etc.) Other bit-packing schemes may be used as well, as is known in the art.

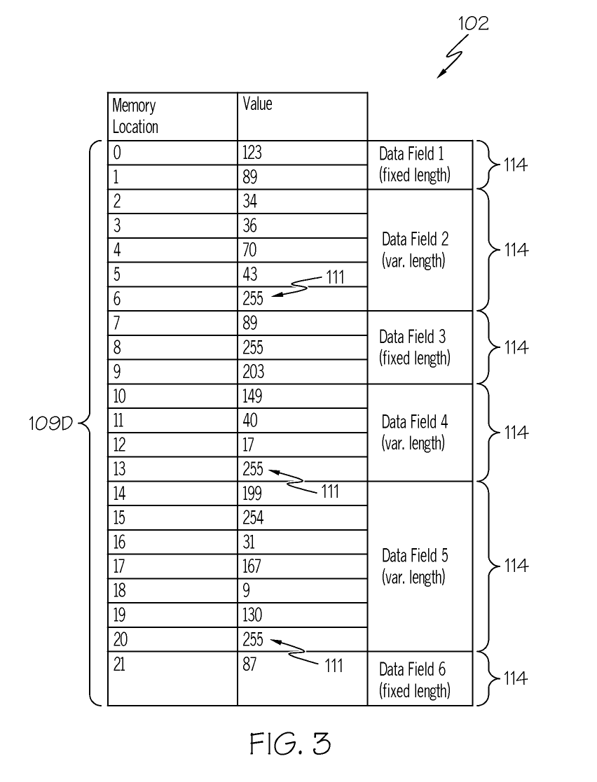

Although the data entries 114 (as depicted in FIGS. 2A and 2B) may have a fixed length (i.e., a fixed number of bytes), some or all of the data entries 114 may have a variable length as well. FIG. 3 depicts a record comprising one or more data entries 114 having variable length. The data entries 114 having a variable length have an end delimiter 111 which indicates to the processor 104 (when reading a data entry of a record from the memory 102) the end of the variable length data entry. In the example shown in FIG. 3, the end delimiter 111 is the number “255,” which is “FF” in hexidecimal. The remaining data bytes in the data entry 114 may not use the same value as the end delimiter 111; that is, the value of the end delimiter 111 must be unique within the context of a variable-length data entry. When reading the record, the processor 104 normally discards the end delimiter and does not serially transmit it along with the other data bytes from the record. In other words, the end delimiter 111 is typically only used to denote the end of a variable-length data entry.

FIG. 3 shows a mixture of fixed-length and variable-length data entries 114 which may be stored in and read from memory 102 by the processor 104 in one embodiment. As depicted in FIG. 2B, all the data entries 114 may be fixed length in another embodiment. Furthermore, all the data entries 114 may be variable length in still another embodiment. When a data entry has a fixed length, it may contain data having the same value as the end delimiter 111 (as shown in Memory Location 8 in FIG. 3) since this value is not relevant in fixed-length data entries. Although the examples described above and shown in FIG. 3 have a width of one byte, memories having other widths may be used as well. Also, the end delimiter 111 may be any suitable value, including zero and 255.

When the processor 104 reads a variable-length data entry 114, it reads the data from the memory 102 until it reaches the end delimiter 111, which indicates to the processor 104 that it has reached the end of the data entry. The processor 104 may then discard the end delimiter and begin reading the next data entry. Variable length data entries 114 may also have a beginning delimiter (not shown). Similar to an end delimiter 111, the beginning delimiter may mark the beginning of the data entry to the processor 104. The remaining data bytes in the variable-length data entry may not use the same value as the beginning delimiter; that is, the value of the beginning delimiter must be unique within the context of a variable-length data entry.

The processor 104 may know which data entries 114 have a fixed length and which ones have a variable length. This may be set up by the manufacturer of the PEM device 101 or may be set up by the user. It is also contemplated that the length or type of data entries 114 may be changed, even after the PEM device 101 has been in operation. In this case, the processor 104 may have to re-write the records into the memory 102 in order to conform to the new format of the data entries.

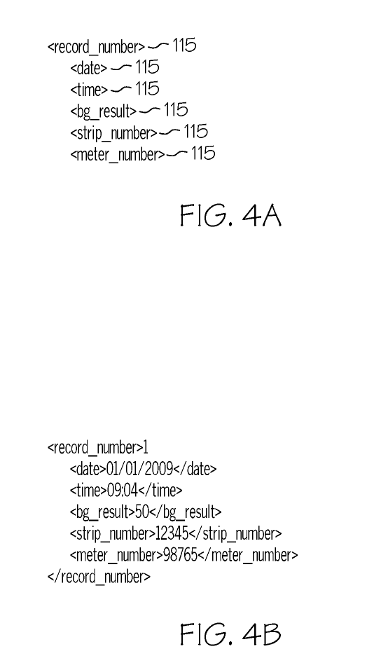

FIG. 4A depicts an exemplary XML template. XML stands for Extensible Markup Language and is a standardized computer language designed to transport and store data. XML is plain text which comprises “tags” defined by the user. Each tag may be bracketed by a “<” symbol and a “>” symbol. Each piece of data stored in an XML file may have an opening and a closing tag. The closing tag may have the “/” symbol inserter after the “<” symbol. For example, a “time” tag may have <time> as an opening tag and </time> as a closing tag. An XML representation of a particular time may be: <time>10:35 pm</time>. XML may also provide the ability to create tree structures as well as attach attributes to data entries, as is known in the art.

The XML template 103 of FIG. 4A may be used by the processor 104 to transmit records in an XML format. The XML template 103 may be stored in the memory 102 or may be received by the PEM device 101 from an external source such as, e.g., PC 108. In the example depicted in FIG. 4, the processor 104 may read the XML template 103 comprising six XML elements 115. Each element 115 may be associated with each data entry 114 of a record 109, such as depicted in FIG. 2A. The first XML element, <record_number>, may associated with the first data entry, “Record No.”; the second XML element, <date>, is associated with the second data entry, “Date”; and so forth. Other methods of associating the XML elements 115 with the data entries may be used as well. The XML elements may or may not include the brackets, i.e., the “<” and the “>.”

The XML template 103 may have some of the XML elements 115 indented (or tabbed), as shown in FIG. 4A, to indicate to the processor 104 and/or PC 108 that these XML elements are children of a prior, non-indented element. Other methods and/or symbols for depicting children, grandchildren, etc. are contemplated as well. In this example, the first element, <record_number>, is the sole parent XML element, and the remaining five XML elements are its children. Other techniques may be used to denote parent and child elements, and more elaborate XML structures may be developed as well.

Continuing with this example, the processor 104 may read the one or more records 109 stored in the memory 102 of the PEM device 101. The processor 104 may then append the XML elements 115 to each associated data entries 114 of the records 109 such that the appended data entries are rendered in XML format. The appended data entries are shown in FIG. 4B. In following with the XML structure of the XML template 103 (FIG. 4A), one appended data entry, <record_number>, is the parent, and the remaining appended data entries are the children.

As discussed herein, the PEM device 101 may have one or more XML templates 103 stored in its memory 102. Alternatively, the PEM device 101 may receive an XML template 103 from the external device, e.g., PC 108 to which it is transmitting the records in XML format. For example, the PEM device 101 may receive the XML template 103 from the PC 108 before it receives a request to transmit its records to the PC 108. The processor 104 of the PEM device 101 may then use the received XML template 103 to serially transmit records in XML format to the PC 108 as is explained hereafter.

Still using the example from FIG. 4B, the appended data entries may be serially transmitted by the processor 104 starting with the <record_number> and continuing until the <meter_number> is sent. The processor 104 repeats this process for each record until some or all of the records 109 stored in memory 102 have been transmitted. For example, the processor may only send out records created in the last two weeks. When sending appended data entries, each character of a data entry may be sequentially sent by the processor 104. For example, when transmitting the “<time>09:04</time>” appended binary data, the processor 104 may transmit the following characters in sequence: <, t, i, m, e, >, 0, 9, :, 0, 4, <, /, t, i, m, e, >. At the end of each line, the processor 104 may send a “carriage return,” a “line feed,” or both.

The processor 104 may transmit additional information before and/or after the appended data entries. For example, the processor 104 may send a header identifying the version of XML and/or the type of encoding used, such as <?xml version=“1.0” encoding=“ISO-8859-1”?>. Other types of information may be transmitted as well, including other types of headers and/or footers.

Embodiments of the present invention will now be described with respect to flow diagrams and flowcharts depicted by FIGS. 5, 6, and 7 each illustrating a PEM device 101 utilizing the present invention. It will be understood that each block of the flowchart and flow diagram illustrations, and combinations of blocks in the flowchart and flow diagram illustrations, can be implemented by computer program instructions, such as provided by control program 112. These program instructions may be provided to a processor 104 to produce a machine, such that the instructions which execute on the processor create means for implementing the functions specified in the flowchart or flow diagram block or blocks. The computer program instructions may be executed by a processor 104 to cause a series of operational acts to be performed by the processor 104 to produce a computer implemented process such that the instructions which execute on the processor provide acts for implementing the functions specified in the flowchart or flow diagram block or blocks. Accordingly, blocks of the flowchart or flow diagram illustrations support combinations of means for performing the specified functions, combinations of acts for performing the specified functions and program instruction means for performing the specified functions.

FIG. 5 depicts a method 200 for serially transmitting records from a PEM device 101 according an embodiment of the present invention. The PEM device 101 may comprise a memory 102 and a processor 104, wherein the processor 104 is in electrical communication with the memory 102. The memory 102 may comprise one or more records 109, each of which may comprise one or more data entries 114. The method 200 may comprise the following acts which may be performed in any suitable order. At act 201, the processor 104 may parse an XML template 103 comprising one or more XML elements 115. Each XML element of the XML template may be associated with one or more data entries 114 of the records 109. At act 202, the processor 104 may electrically read the one or more records 109 stored in the memory 102. At act 203, the processor 104 may append the XML elements (from the XML template 103) to the associated data entries of each record 109, such that the appended data entries are in XML format. At act 204, the processor 104 may serially transmit the appended data entries of each record in XML format. One or more of these acts may be repeated until all records 109 have been transmitted.

The method may also comprise an act of encrypting some or all of the data entries 114 of the records 109. The regulations of medical devices may place stricter requirements on therapeutically significant data, compared to therapeutically non-significant data. An example is the amount of insulin bolus to be delivered versus historical data collected over time. Since XML is plain text format, the XML template 103 may contain a privacy indication for some or all of the data entries. The method may recognize data entries with a privacy need and apply encryption to the resulting transmission of records 109 in XML format. The processor 104, after locating the XML template 103 corresponding to the record 109, may determine whether the XML template 103 indicates if any records 109 and/or data entries have a privacy attribute. The processor 104, upon receiving an indication that the record 109 and/or data entry has a “private” indication from the XML template 103, may encrypt the data entries using any conventional or yet-to-be-discovered techniques. As an example, the processor 104 may encrypt records by using an Advanced Encryption Standard (AES) adopted by the National Institute of Standards and Technology (NIST) such as the Rijndael algorithm. Other algorithms may be used as well, including but not limited to the Serpent algorithm and the Twofish algorithm. Furthermore, all records may be encrypted or only portions of the records may be encrypted. As an example, the medically relevant information may be encrypted (such as bG levels), and other information may not be encrypted (such as dates and times). Similarly, the XML tags (discussed hereinafter) may or may not be encrypted as well.

The method may also comprise the act of adding a digital signature to the data transmission. The XML template 103 may indicate whether there is medically significant data and whether the digital signature is to be applied to the resulting document transmitted from the PEM device 101. If the XML template 103 indicates that a digital signature is required, the method may add a digital signature. Methods to generate a digital signature may include but are not limited to the Digital Signature Algorithm (DSA) and the digital signature algorithm developed by the SAFE-BioPharma Association Other techniques to generate a digital signature may also be used, as is known in the art.

To determine the proper method of parsing binary data into XML, there may be four scenarios that can occur based on whether data structure is known ahead of time during device design or whether the communicated data entries are of fixed or variable length. Table 1 shows these four scenarios.

TABLE 1

| | Fixed-Length | Variable- and/or Fixed- |
|---|---|---|
| | Entries Only | Length Entries |
| Static (design defined) | Option 1 | Option 2 |
| Dynamic (runtime defined) | Option 3 | Option 4 |

For Option 1, the data structure of the record 109 (i.e., the number and types of data entries) is defined when the meter is designed and consists of only fixed-length data entries. The data entries 114 are associated to the XML elements 115 according to pattern that can be mapped directly to the XML template 103. The XML elements are appended to each of the associated data entries until all data entries of each record are processed. This option may use but does not require an end delimiter 111 to separate data in memory.

For Option 2, the data structure of the record 109 is defined when the PEM device 101 is designed and comprises fixed-length and/or variable-length data entries 114. This option, in addition to Option 1, addresses variable-length data entries. The memory allocation now must use an end delimiter 111 to indicate the end of variable-length data entries. One possible implementation is to store fixed-length data entries in the beginning of the record 109; and after that store the variable-length data entries delimited by the known end delimiter. Each variable-length data entry is preceded by the opening XML tag, followed by the data until the end delimiter 111 is encountered. The closing XML tag may then be appended. The delimiter itself is not typically communicated into XML data. This solution requires that the end delimiter is selected appropriately so that it cannot be encountered with the data entry itself.

For Option 3, the data structure may be defined up to the time when the records 109 are to be transmitted. This is similar to Option 1, but the XML template can be modified during runtime. This implies that the original binary record storage may not correspond anymore to the new or modified XML template. As such, the original records may either be re-allocated to match the new XML template 103 or the old template may be preserved. This second option is similar to implementations that need multiple XML templates to communicate different XML data structures from the same device. Yet another option exists for situations in which the new data entries are optional and thus the existing records 109 can be rendered with empty optional data entries, without necessarily reorganizing the storage.

For Option 4, the data structure is defined at runtime and consists of fixed-length or variable-length data entries 114. The solution to this option is derived from the solutions to Option 2 and Option 3. The variable-length data entries can be represented via the end delimiter method and modifying the XML template 103 can be resolved for fixed and variable data entry lengths as specified in Option 3.

The above options assume that the XML template 103 can represent the tree-like structure of XML. In other words, one XML element 115 can consist of more sub-elements and thus represent complex structures, for example an address consisting of a street, city, state and zip code. This may not be a problem since the XML template 103 can mirror such tree structure by pointing from one template element to another part of the template that represents the sub-elements of complex structure.

If the XML element 115 is optional and does not contain any value, this element may be either left out from the final XML or may be communicated as empty element, depending on the requirements for XML data format. Any of these requirements can be fulfilled by considering an optional data entry as variable-length data entry and representing it (in memory) as an end delimiter without any data.

A system of multiple devices may require exchange of data originating from each of the multiple devices. The following situations may occur with, for example, a system with 3 devices A, B and C, which demonstrates the variability in communication needs within the system. Device A may only generate data (A-Records) (e.g. via measurement engine or historical record keeping), store data, and forward data to other devices. Device B may generate data (B-Records) and accept data from device A. Device B may either transmit only its own B-Records or combined A-Records and B-Records, depending on the presence of device A in the system. Device C may not generate its own data, but accepts A-Records from device A, B-Records from device B, or Combined Data from both devices A and B.

The XML template 103 may uniquely describe each PEM device 101, but the PEM devices may allow a combination of templates. For example, if a system has two PEM devices, A and B, device A contains may contain its own XML template, while device B may contain both XML templates A and B. In addition, template A may store activation information directly or the activation information is stored in the memory 102. The memory 102 further stores information on which data regions belong to which templates. The variation of the algorithm that uses multiple templates assumes that the device is aware of which binary records 109 in the memory 102 correspond to a particular XML template 103.

Transmitting the XML template 103 to the PEM device 101 when needed may provide flexibility in a multi-device system. Continuing with the above example, as device A is added into the system, it broadcasts its presence so it can activate XML template A in the device B and Device C. Similarly device B broadcasts its presence so its XML template can be activated on the device C. The activation of XML templates is guided by whatever pairing algorithm is used to discover devices. This will optimize the data transmission in cases where device A or Device B is not present in the system. In another embodiment, the pairing algorithm allows for transmission of the template, eliminating the need for the need of having all the templates of the system preloaded on each device.

After appending the data entries of the one or more records 109 with the XML elements 115 of the XML file, the processor 104 may temporarily or permanently store the appended data entries (in XML format) in the memory 102. The processor 104 may append other information to the data entries, as previously discussed herein, so as to create an “XML file” in memory 102. This XML file may be in XML format, and may contain one or more of the records 109 stored in the PEM device 101. Assembling and storing the XML file in memory may permit the PEM device 101 to perform additional functions, such as combining one or more XML files before transmitting the combined XML file.

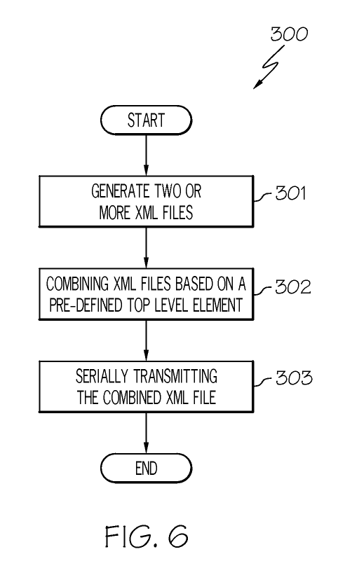

FIG. 6 depicts a method 300 which permits a PEM device 101 to combine two or more XML files. The acts may be performed in any suitable order. At act 301, the PEM device may create two or more XML files using the method of FIG. 5 or some other method. At act 302, the processor 104 may combine these XML files into a single XML file, based on a pre-determined top level element. At act 303, the processor 104 may serially transmit the single, combined XML file. The top level element is generally not part of the XML template 103. Instead, the top level element may be universally agreed upon by the PEM device 101 and any other devices in communication therewith. The top level element may indicate how the two or more XML files are to be combined. For example, the top level element may indicate that the combined XML files are to have a single, first-level heading, such as “<combined_xml_files>,” while each of the two or more XML files (to be combined) are to have a sub-level heading, such as “<first_xml_file>,” “second_xml_file>,” etc. Other similar structures and headings may be used as well.

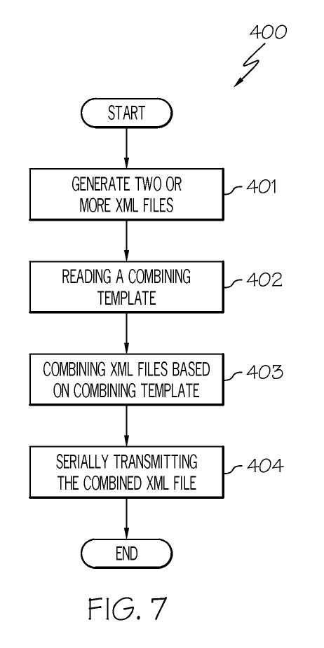

FIG. 7 depicts another method 400 which permits a PEM device to combine two or more XML files. The acts may be performed in any suitable order. At act 401, the PEM device may create two or more XML files using the method of FIG. 5 or some other method. At act 402, the processor 104 may read or receive a combining template which provides instructions on combining the two or more XML files into a single, combined XML file. At act 403, the processor 104 combines these XML files into a single XML file, based on the combining template. At act 404, the processor 104 may serially transmit the single, combined XML file. The combining template may indicate how the two or more XML files are to be combined. For example, the combining template may provide an XML structure for combining the files. As one example, the combining template may indicate that the combined XML files are to have a single, first-level heading, such as “<combined_xml_files>,” while each of the two or more XML files (to be combined) are to have a sub-level heading, such as “<first_xml_file>,” “second_xml_file>,” etc. As another example, the combining template may provide a structure which permits the processor to reorganize the two or more XML files into a single, comprehensive, combined XML file. In one embodiment, the combining template may extract the record number, the date, and the bG level result from each of the two or more XML files and combine them according to record number or date. Combining templates having other structures and/or hierarchies is contemplated.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A method for serially transmitting one or more records from a portable electronic medical device to an external device, wherein the portable electronic medical device comprises a memory and a processor, the memory is in electrical communication with the processor, the memory comprises the one or more records, each record comprises one or more data entries, the method comprises:
having the processor parse an XML (Extensible Markup Language) template, the XML template including one or more XML elements associated with one or more data entries;
having the processor read the one or more records;
having the processor append the XML elements to the associated data entries of each record such that the appended data entries are in XML format; and
having the processor serially transmit the appended data entries of each record to the external device.

2. The method of claim 1 wherein at least one of the XML elements of the XML template specifies data encryption for the associated data entry, and the method further comprises having the processor encrypt the corresponding data entry.

3. The method of claim 1 further comprising serially transmitting a digital signature.

4. The method of claim 1 wherein at least one of the one or more data entries comprise an end delimiter indicating the end of the data entry.

5. The method of claim 4 wherein the at least one data entry has a variable length.

6. The method of claim 4 wherein the at least one data entry further comprises a beginning delimiter indicating the beginning of the data entry.

7. The method of claim 1 wherein the XML template is stored by the processor in the memory.

8. The method of claim 1 further comprising having the processor receive the XML template from an external source.

9. The method of claim 8 wherein the external source is another device in communication with the portable electronic medical device.

10. The method of claim 1 further comprising having the processor receive the XML template from the external device.

11. A method for serially transmitting one or more records from a portable electronic medical device to an external device, wherein the portable electronic medical device comprises a memory and a processor, and the method comprises:
having the processor read from the memory two or more XML (Extensible Markup Language) files, wherein each XML file comprises one or more records;
having the processor combine the two or more XML files into a single, combined XML file, based on a pre-determined top level element; and
having the processor serially transmitting the single, combined XML file to the external device.

12. The method of claim 11 wherein a digital signature is appended by the processor to the single, combined XML file.

13. A method for serially transmitting one or more records from a portable electronic medical device to an external device, wherein the portable electronic medical device comprises a memory and a processor, and the method comprises:
having the processor read from the memory two or more XML (Extensible Markup Language) files, wherein each XML file comprises one or more records;
having the processor read a combining template which provides instructions on combining the two or more XML files into a single, combined XML file;
having the processor combine the two or more XML files into a single, combined XML file, based on the combining template; and
having the processor serially transmitting the single, combined XML file to the external device.

14. The method of claim 13 wherein a digital signature is appended by the processor to the single, combined XML file.

15. A portable electronic medical device comprising:
a communication device;
a memory for storing one or more records, each record having one or more data entries;
a processor in electrical communication with the communication device and memory; and
a control program accessible by the processor to direct the processing of the one or more records and data entries by the processor, the control program when executed on the processor causes the processor to:
read the one or more records from the memory,
parse an XML (Extensible Markup Language) template comprising one or more XML elements associated with the one or more data entries,
append the XML elements to the associated data entries of each record such that the appended data entries are in XML format, and
serially transmit the appended data entries of each record via the communication device.

16. The device of claim 15 wherein at least one of the XML elements of the XML template specifies data encryption for the associated data entry, and the control program further causes the processor to encrypt the corresponding data entry.

17. The device of claim 15 wherein the control program further causes the processor to transmit a digital signature.

18. The device of claim 15 wherein the at least one data entry has a variable length.

19. The device of claim 18 wherein the control program further causes the processor recognize an end delimiter in a variable-length data entry indicating the end of the data entry.

20. The device of claim 18 wherein the control program further causes the processor to recognize a beginning delimiter in a variable-length data entry indicating the beginning of the data entry.

21. The device of claim 15 wherein the XML template is stored in the memory.

22. The device of claim 15 wherein the control program further causes the processor to receive the XML template from an external source.

23. The device of claim 22 wherein the external source is another device in communication with the portable electronic medical device.
